(19) United States
(12) Patent Application Publication
(10) Pub. No.: US 2003/0231216 A1
(43) Pub. Date: Dec. 18, 2003

(54) Internet navigation tree with bookmarking and emailing capability

(75) Inventors: Gerald Francis McBrearty, Austin, TX (US); James Stanley Tesauro, Austin, TX (US); Ravinder Paul Wadehra, Austin, TX (US)

Correspondence Address: Mark D. Simpson, Synnestvedt & Lechner, 2600 Aramark Tower, 1101 Market Street, Philadelphia, PA, 19107-2950, US

(73) Assignee: International Business Machines Corp., Armonk, NY

(21) Appl. No.: 10/171,844

(22) Filed: Jun. 13, 2002

(51) Int. Cl. G09G 5/00

(52) U.S. Cl. 345/855

(57) ABSTRACT

A graphical navigation tree is provided that graphically illustrates all links (e.g., web sites) from all navigation paths that have been traversed since a web browser session was invoked. The navigation tree can be displayed constantly or be invoked only upon activation by the user. In addition, the user can be given the option of designating a particular web site on a particular navigation path with a mouse pointer and upon clicking the mouse key, be immediately brought to the URL corresponding to that web site. Further, some or all of the navigation tree may be designated for bookmarking and/or for electronic forwarding to others via, for example, email.

### BACKGROUND OF THE INVENTION

1. Field of the Invention

This invention relates generally to information retrieval in a computer network. More particularly, it relates to an improved method and Graphic User Interface (GUI) for navigating Web pages in an Internet environment and preserving an interactive record of the navigation path(s).

2. Description of the Related Art

It is well known to couple computer systems into a network of computer systems so that the collective resources available within the network may be shared among users. The Internet has brought this sharing of computer resources to a much wider audience.

The World Wide Web, or simply “the Web”, is the Internet's information retrieval system; it is the most commonly used method of transferring data in the Internet environment. Client machines accomplish transactions to Web servers using the Hypertext Transfer Protocol (HTTP), which is a known application protocol providing users access to files (e.g., text, graphics, images, sound, video) using a standard page description language known as the Hypertext Markup Language (HTML). HTML provides basic document formatting and allows the developer to specify “links” to other servers and files. In the Internet framework, a network path to a server is identified by a Uniform Resource Locator (URL) having a specific syntax for defining a network connection.

Retrieval of information is generally achieved by the use of an HTML-compatible “browser”, e.g., Netscape Navigator, at a client machine. Web browsers are Graphic User Interfaces (GUI's) that have become the primary interface for access to many network and server services. When the user of the browser specifies a link via a URL, the client issues a request to the domain name service (DNS) to map a hostname in the URL to a particular Internet address (called an IP address) at which the server is located. The naming service returns a list of one or more IP addresses that can respond to the request. Using one of the IP addresses, the browser establishes a connection to a server. If the server is available, it returns a document or other object (often formatted according to HTML, which is the standard for Web page description).

The entry of the URL in the entry field of a browser can be a difficult task for many users. While the URL for the main Web page of a major company can be relatively brief, e.g., http://www.ibm.com/, subsidiary pages can have very lengthy and non-intuitive URLs. As an example, the URL for IBM's ?Small Business Center@ page, an internal page accessible from the main IBM web page, is as follows:

http://www-1.ibm.com/businesscenter/us/smbusapub.nsf/detailcontacts/SBCenter5988.

Recognizing the difficulties involved, the developers of browsers have provided several useful “shortcut” methods for navigating the Web, including “hyperlinks” and the “Forward” and “Back” navigation buttons.

During a web navigation session, the user typically will visit a first web page (e.g., a home page) identified by a particular URL, and this web page often acts as a “springboard” to additional web locations via the use of hyperlinks. As is well known, hyperlinks allow a user to navigate to a particular location on the Web without having to enter URLs; instead, the user clicks on a hyperlink and is automatically directed to the URL associated with the hyperlink.

Most web navigation sessions involve a series of hops from one web page to another web page to another web page, etc. via activation of hyperlinks on the web page being viewed. As a user proceeds forward from one web page to the next, “navigation path” is formed beginning from the home page and extending to the last web page along the forward progression. With each forward movement, the navigation path “grows” longer. At some point along the navigation path, the user will reach a point at which they wish to go no further. Very often, the user may wish to return back to a web page several “hops” back. To avoid making the user have to remember the URL of the previously visited location, web-browser designers developed the above-described navigation buttons. These navigation buttons typically are found near the top of the web browser window and may be represented by a left-pointing (Back) or right-pointing (Forward) arrow.

Using the navigation buttons, the user can, for example, simply click the Back button to return to the immediately previously visited web page. By repeatedly hitting the Back button, the user will eventually return to the desired location. Additionally, some web browsers provide a drop down menu associated with the Back button which, when activated, displays a list of the previously visited web pages in the most recent navigation branch, so that the user can jump directly to a web page two or more “hops” back.

While providing a very useful tool for the web browser, the usefulness of the Back and Forward navigation buttons is limited by the manner in which they operate. FIG. 1 is a tree diagram illustrating one of these limitations. Tree diagrams comprise nodes interconnected by branches as is well known. In the context of a web session, the initial home page accessed at the start of a session would be the first node in the tree, and clicking on a hyperlink would create a branch to a new node, the new node representing the web page associated with the hyperlink. With each successive hyperlink selection, a new branch and node is created in the tree diagram.

Referring to FIG. 1, suppose a particular user begins from a home page A (node 102); clicks a hyperlink to navigate to page B (node 104); from there, clicks another hyperlink to navigate to page C (node 106); and then clicks yet another hyperlink to navigate to page D (node 108). Navigating to page B creates a branch to node 104, and then navigating to page C and then page D creates additional branches to nodes 106 and 108, respectively. The term “navigation path” is used herein to describe the path from the initial home page (node 102 in this example) to the last web site visited before going back towards the home page. Thus, for example, the path from page A to page D (node 102 to node 108) is a navigation path. After viewing the information on the web page at page D, the user then desires to proceed back to page B. Clicking the Back button once will bring the user to page C, and clicking the Back button again will bring the user to page B. Alternatively, if the browser has a Back drop-down menu, the user could activate the drop down menu and select “page B” from the list, to go directly to page B.

If the user now traverses to page C¹ (node 110), a new navigation path, from page A (node 102) to page B (node 104) to page C¹ (node 110), is established. Once this new navigation path is established, however, portions of the navigation path originally traveled and the web pages associated therewith (page C; page D) are inaccessible via the navigation buttons. In other words, using prior art browser technology, going back to a previous node in the navigation path and traversing off on a different branch “erases” or shrinks earlier traversed branches/nodes from the memory associated with the Forward button. Only a direct path back to the web pages along the current navigation path is available. Accordingly, it would be desirable to be able to navigate forward and backward along plural navigation paths without deleting return access to all but the current active navigation path.

### SUMMARY OF THE INVENTION

In accordance with the present invention, a graphical navigation tree is provided that graphically illustrates all links (e.g., web sites) from all navigation paths that have been traversed since a web browser session was invoked. The navigation tree can be displayed constantly or be invoked only upon activation by the user. In addition, the user can be given the option of designating a particular node on a particular navigation path (e.g., with a mouse pointer) and upon designating that node (e.g., by clicking the mouse key), be immediately brought to the location (e.g., a web site) corresponding to the designated node. Further, some or all of the navigation tree may be designated for bookmarking and/or for electronic forwarding to others via, for example, email.

### BRIEF DESCRIPTION OF THE DRAWINGS

FIG. 1 illustrates a typical tree diagram;

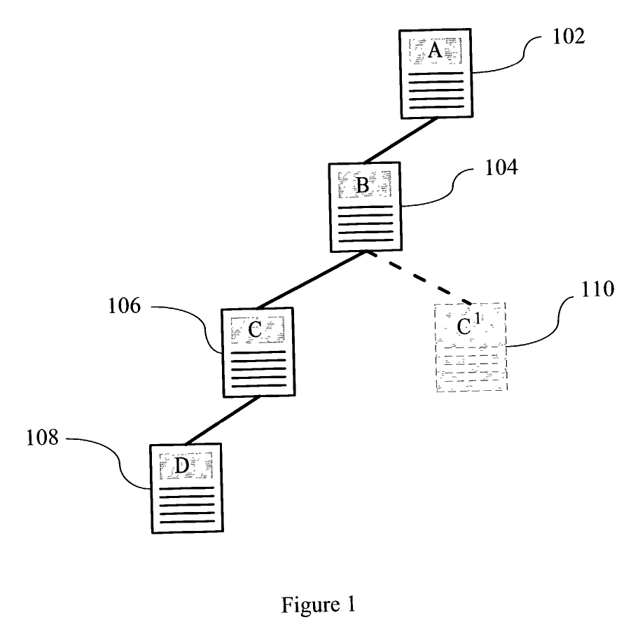

FIG. 2 illustrates a graphical tree diagram, created in accordance with the present invention, of a typical web navigation session beginning from an initial homepage;

FIG. 3 illustrates an alternative graphical representation of the various navigation paths of the web search illustrated in FIG. 2;

FIG. 4 illustrates an example of how an active navigation tree can be displayed on a web browser; and

FIG. 5 is an example of a flowchart illustrating an example of the steps performed by the present invention to set up and invoke the navigation tree.

### DETAILED DESCRIPTION OF THE PREFERRED EMBODIMENTS

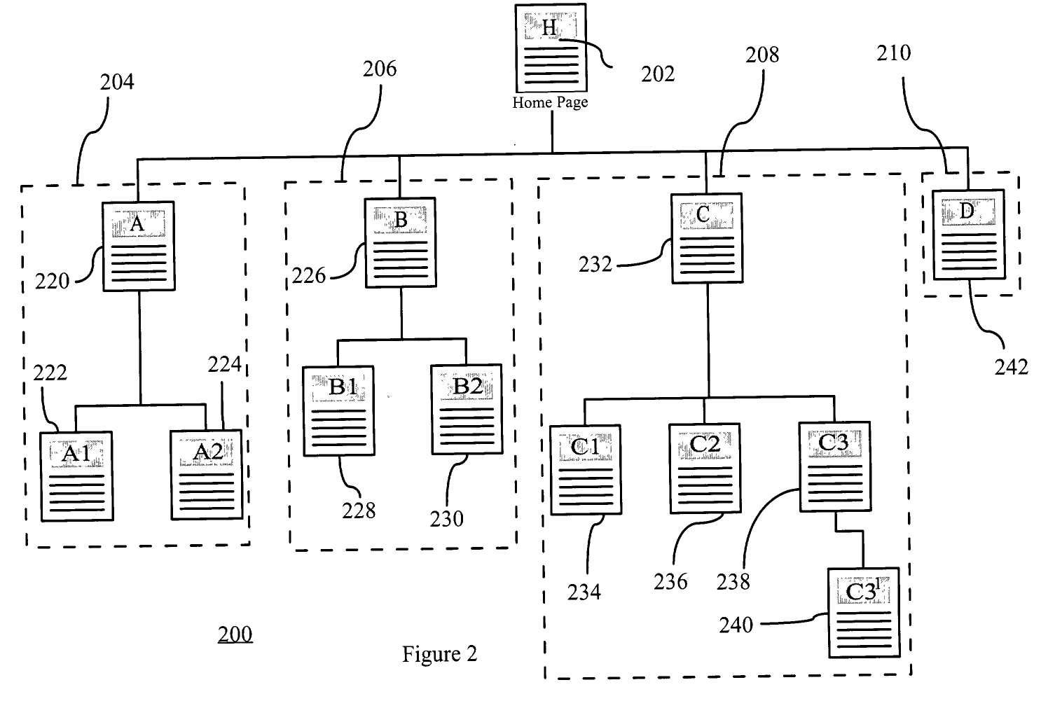

FIG. 2 illustrates a tree diagram 200, created in accordance with the present invention, of a typical web navigation session beginning from an initial home page H (node 202). As an example, home page H might represent the initial page appearing on a web browser when a user launches the web browser application. The tree diagram 200 is displayable to the user either on demand or continuously during the web session, at the option of the user. Each of the symbols representing the nodes comprise selectable indicators associated with the information (e.g., web page) that they represent. Thus, by designating a particular node symbol (e.g., with a mouse pointer) and then selecting the node symbol (e.g., by clicking a mouse button), the information associated with that node will be retrieved.

In the example of FIG. 2, the user begins traversing a first branch group 204 by clicking on a hyperlink that brings the user to page A (node 220). From page A, the user clicks an additional hyperlink that brings the user to page A1 (node 222). The current navigation path at this point is: home page H (node 202)-to-page A (node 220)-to-page A1 (node 222). The user then hits the Back button to return to page A, where the user then decides to visit page A2 (node 224) by clicking on a hyperlink designating page A2. This action creates a new navigation path: home page H (node 202)-to-page A (node 220)-to-page A2 (node 224).

The user can then use the prior art Back “drop down menu”, which will display the previous selections in the active path, i.e., home page H and page A. In this example, if the user selects home page 202 from the Back drop down menu, the user will be brought directly back to home page 202. If the user then selects a hyperlink designating page B (node 226), a new branch group 206 will be created. From page B, the user can activate a hyperlink to travel to page B1 (node 228); click the Back button to return to page B, then click a hyperlink to bring the user to page B2 (node 230). Once finished on page B2, the user can click the Back button once to return to page B, then again to return to home page H.

From home page H, the user can create a new branch group 208 by clicking a hyperlink from homepage H designating page C (node 232). From page C, the user can click a hyperlink to go to page C1 (node 234); click the Back button to return to page C; click a hyperlink to travel to page C2 (node 236); click the Back button again to again return to page C. The user can then click a hyperlink for page C3 (node 238); from page C3, the user can click a hyperlink to travel to page C3¹ (node 240). At this point, the user may return to home page H either by clicking the prior art Back button three times or by activating the prior art Back button drop down menu and proceeding directly to homepage H.

Finally, in the example of FIG. 2, the user can click on a hyperlink from homepage H that designates page D (node 242), bringing the user to page D.

In the example of FIG. 2, if we assume that the web session proceeded in the above-described sequence, the user can click the prior art Back button from page D to travel back to homepage H, and can click the Forward button from homepage H at that point to return to page D. However, using prior art systems, no record of the prior branch groups 204, 206, or 208 is maintained and, thus, no simple method of returning to previously-visited links in these prior navigation paths exists.

In accordance with the present invention, a list of each web page along a navigation path visited in a particular web session is automatically stored and is associated with its originating page. In addition, a graphical representation of the various navigation paths traversed during the present web session is generated and made available to the user to thereby enhance their web experience. The process allows the display of the web session in an interactive mapped format. For example, a tree diagram such as that illustrated in FIG. 2 can be, in accordance with the present invention, invoked visually on the user's screen by clicking, for example, a “navigation tree” button on the browser. Thus, if the user is currently viewing page D and desires to go immediately back to page C3¹, the user can simply activate the navigation tree button from the browser, which will display a graphical image similar to the image illustrated in FIG. 2, and the user can then click on the icon identifying page C3¹ to be brought immediately to that page. It is noted that jumping from branch 210 to branch 208 will not modify the existing tree. The navigation tree is only modified when a newly-visited link (relative to a particular web session) is accessed. Alternatively, a separate frame can be established using well-known programming techniques so that the navigation tree is always displayed on a portion of the user's computer screen.

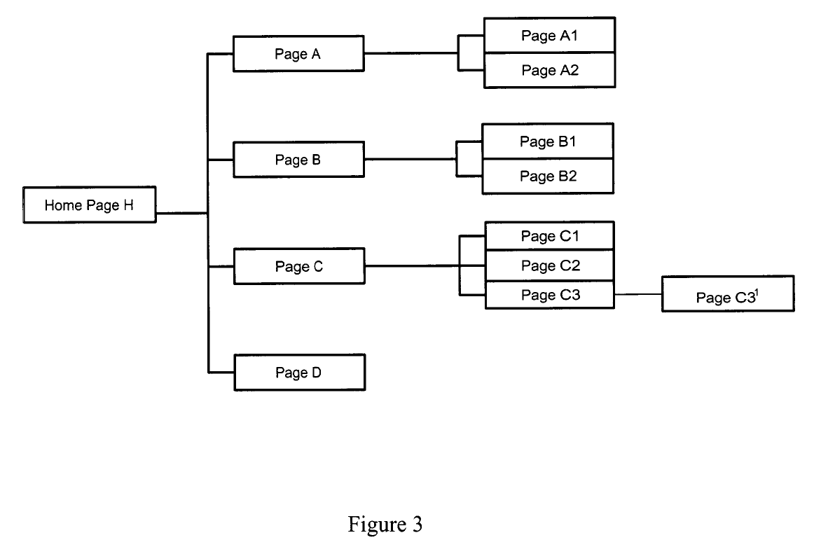

It is understood that the navigation tree illustrated in FIG. 2 is only one of many possible representations of the navigation tree of the present invention. The selectable indicator, for example, can comprise icons, clickable hyperlinks in text format, or any other means for allowing selection of the node with which they are associated. Any known method of actively displaying the various navigation paths of the web session can be used and still fall within the scope of the present invention. For example, FIG. 3 illustrates an alternative graphical representation of the various navigation paths of the web search illustrated in FIG. 2. It is also understood that the navigation tree may be constantly displayed to the user during the web session instead of being selectively invoked as described above.

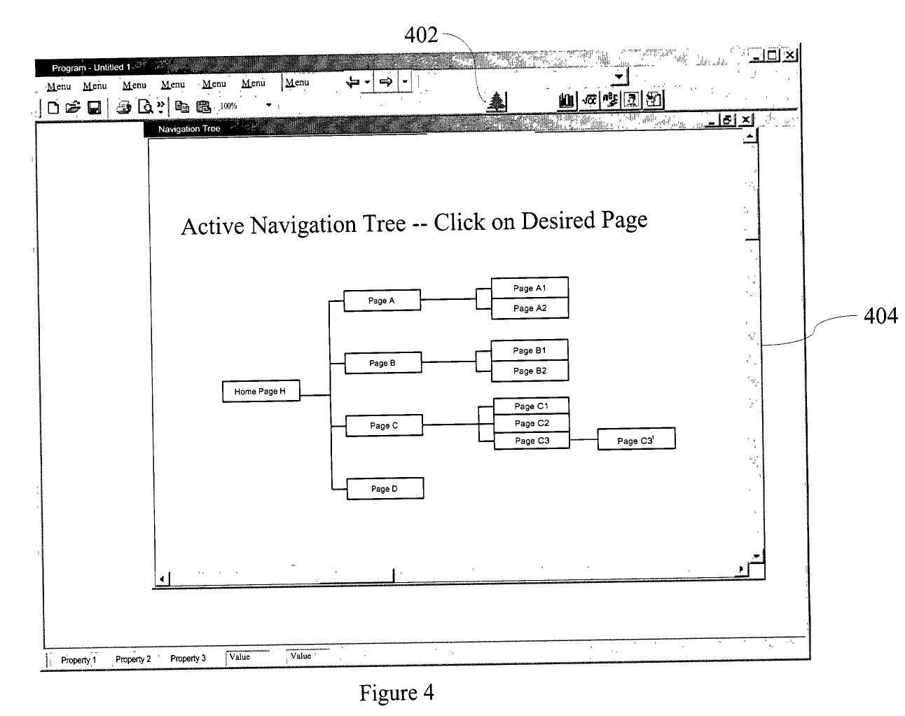

FIG. 4 illustrates an example of how the active navigation tree can be displayed on a web browser. As illustrated in FIG. 4, a button 402 is included which, when activated, will display a window 404. As noted, the window includes instructions to click on a particular web page along a navigation path to be immediately brought to that location.

In addition to having the ability to activate and immediately traverse the navigation tree as illustrated in FIG. 4, in accordance with a preferred embodiment of the present invention, the user may also designate some or all of the active navigation tree to be saved, for example, in a “Bookmarks” file of the web browser as is well known. Thus, the user may save the web navigation tree for a particular search in the Bookmarks file and name the particular tree with a name that will identify the particular search being performed at that time. Further, if desired, the user may designate portions of the active navigation tree, e.g., only branch groups 206 and 208 of FIG. 2, for bookmarking, if desired. Standard mouse functionality, e.g., “cut and paste,” can be used to designate the portion to be saved. In addition, the user may designate some or all of the navigation tree, and then email the designated portion of the active navigation tree to an email address for use by the recipient.

In the examples illustrated in FIGS. 2 through 4, the various web pages along the navigation paths traversed during the the web search are designated by generic terms (e.g., page A, page B, page B², etc.). It is understood that the actual names used may consist of the URL, the name that appears in the title bar when viewing a particular URL, or both. The precise manner in which the names are displayed for the user can be selectable by the user in a well-known fashion using an “Options” feature for the navigation tree button. Further, if desired, the user may rename any or all of the nodes displayed to names of their choosing if desired. In addition, while the examples given above make specific reference to web browsing, the present invention is equally applicable to any situation involving “web-like” navigation where files are accessed by successive access from one file to the next.

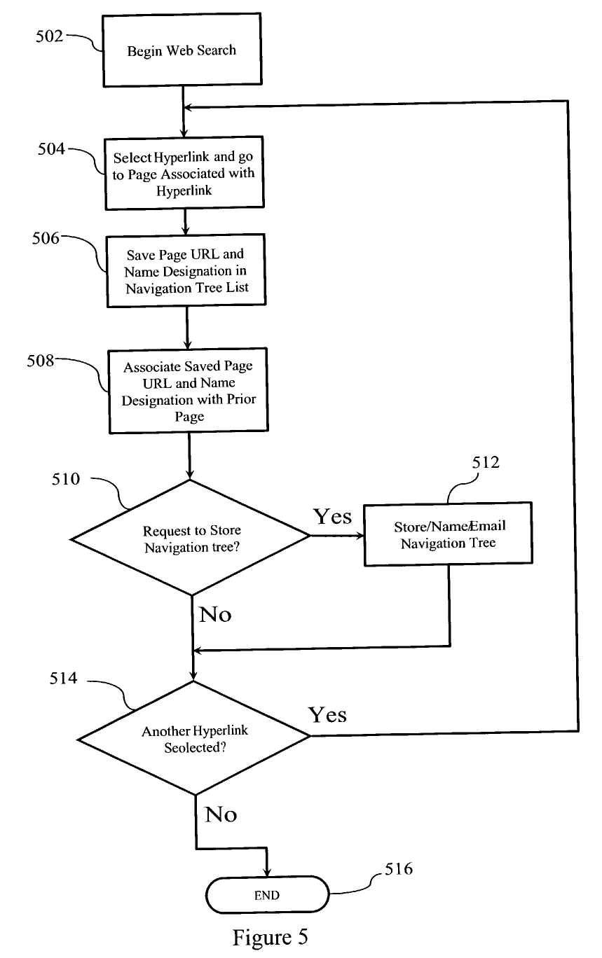

FIG. 5 is an example of a flowchart illustrating the steps performed by the present invention to set up and invoke the navigation tree in a web browsing environment. At step 502, the user begins the web search, i.e., by launching a particular homepage. At step 504, the user selects a hyperlink from the homepage and the browser retrieves and displays the link associated with the hyperlink. It is understood that, rather than selecting a hyperlink, if desired, the user may manually type in a URL identifying a web page that the user desires to view.

At step 506, the URL of the selected web page is saved, along with a name designation for that page (e.g., the URL, the name in the title bar, or both).

At step 508, the saved page URL and name designation is associated with the immediately preceding page being viewed by the user. This association is used to create the graphical link between nodes in the tree diagram. The precise method for making this association, and for creating the tree diagram based on the associations, is known to those of ordinary skill in the art and is not discussed further herein. By carrying out steps 504-508, the navigation tree is created and as additional links are selected, the navigation tree “grows.”

At step 510 a determination is made as to whether or not the navigation tree assembled via steps 504 through 508 is going to be stored for later retrieval. If affirmative, at step 512, the navigation tree is stored and named for later retrieval. Alternatively, the navigation tree can be emailed at this point by designating some or all of the tree for emailing. Further, it is understood that, as discussed above, portions of the tree may be designated for storage rather than storing the tree in its entirety. Once the storage is completed, at step 514, it is determined whether or not another hyperlink has been selected. If another hyperlink has been selected the process proceeds back to step 504 and the same sequence (steps 504, 506, 508, and 510) are followed, thereby creating a new navigation tree reflecting the newly-selected link.

If at step 514 it is determined that there are no additional hyperlinks selected, then the process proceeds immediately to step 516 where the process ends.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. An improved graphical user interface (GUI) having a navigation tree selection button, the improvement comprising:
a graphical navigation tree displaying one selectable indicator associated with each website visited during a web session upon manipulation of said navigation tree selection button.

2. An improved GUI as set forth in claim 1, wherein selection of one of said selectable indicators directs said GUI to access the website associated with said one of said selectable indicators.

3. An improved GUI as set forth in claim 2, wherein said navigation tree displays said selectable indicators in a mapped format whereby all navigation paths followed during said web session are visually discernable.

4. An improved GUI as set forth in claim 3, wherein said navigation tree is saveable in a retrievable format.

5. An improved GUI as set forth in claim 3, wherein portions of said navigation tree are designateable for saving in a retrievable format.

6. An improved GUI as set forth in claim 3, wherein said navigation tree is saveable in an electronically transmittable format.

7. An improved GUI as set forth in claim 3, wherein portions of said navigation tree are designateable for saving in an electronically transmittable format.

8. An improved GUI as set forth in claim 2, wherein said selectable indicators comprise graphical icons that uniquely identify their associated website.

9. An improved GUI as set forth in claim 2, wherein said selectable indicators comprise clickable hyperlinks displayed in textual format.

10. A method for automatic return to web sites visited in a web session, comprising the steps of:
creating a graphical navigation tree displaying one selectable indicator associated with each web site visited during said web session; and
enabling each of said selectable indicators so that upon selection of one of said selectable indicators, the web site associated with said one of said selectable indicators is accessed.

11. A method as set forth in claim 10, wherein said navigation tree displays said selectable indicators in a mapped format whereby all navigation paths followed during said web session are visually discernable.

12. A system for automatic return to web sites visited in a web session, comprising:
means for creating a graphical navigation tree displaying one selectable indicator associated with each web site visited during said web session; and
means for enabling each of said selectable indicators so that upon selection of one of said selectable indicators, the web site associated with said one of said selectable indicators is accessed.

13. A system as set forth in claim 12, wherein said navigation tree displays said selectable indicators in a mapped format whereby all navigation paths followed during said web session are visually discernable.
